(19) United States
(12) Patent Application Publication
(10) Pub. No.: US 2020/0080335 A1
(43) Pub. Date: Mar. 12, 2020

(54) FLANGE SEGMENT FOR A WIND TURBINE, STEEL TOWER RING SEGMENT, AND METHOD

(71) Applicant: Wobben Properties GmbH, Aurich (DE)

(72) Inventor: Roy KERSTEN, Hohenwarthe (DE)

(21) Appl. No.: 16/494,241

(22) PCT Filed: Mar. 21, 2018
(86) PCT No.: PCT/EP2018/057087

§ 371 Date: Sep. 13, 2019

(30) Foreign Application Priority Data
Mar. 22, 2017 (DE) 10 2017 106 201.7

(51) Int. Cl. E04H 12/08; F03D 13/20

(52) U.S. Cl. CPC E04H 12/085; F05B 2230/232; F05B 2240/912; F03D 13/20

(57) ABSTRACT

A flange segment for a wind turbine steel tower ring segment, to a wind turbine tower portion, to a wind turbine tower, to a wind turbine and to a method for producing a wind turbine steel tower ring segment is provided. Also provided is a flange segment for a wind turbine steel tower ring segment, comprising a partially ring shaped basic body which extends from a first end to a second end in the ring direction, having an upper side and a lower side opposite the upper side, an inner circumferential side and an outer circumferential side, and a first abutment side on the first end and a second abutment side on the second end, and a flange projection which is arranged on the upper side of the basic body and extends substantially from the first end to the second end in the ring direction.

### BACKGROUND

### Technical Field

The invention relates to a flange segment for a wind turbine steel tower ring segment, to a wind turbine tower portion, to a wind turbine tower, to a wind turbine and to a method for producing a wind turbine steel tower ring segment.

### Description of the Related Art

Wind turbines of the type stated at the outset are sufficiently well known. The currently most conventional type of a wind turbine is the so called horizontal axis wind turbine which is customarily equipped with three rotor blades, with wind turbines having one, two, four or more rotor blades also being possible. Wind turbines have increasingly larger design forms in order, on the one hand, to be able to achieve a higher rated power and, on the other hand, to allow better utilization of the wind.

In addition to a rotor arranged on a nacelle, wind turbines generally comprise a tower on which the nacelle with the rotor is arranged so as to be rotatable about a substantially vertically oriented axis. Towers are generally slender structures which preferably have a large height and further preferably have comparatively small dimensions orthogonally to this height. Towers preferably consist substantially of concrete and/or steel or comprise said materials. The design spectrum for towers ranges from lattice constructions over tubular steel towers with or without cable bracing to concrete structures. Tubular steel towers can consist of an individual component or a plurality of components or comprise such components.

Towers can have cylindrical and/or conical portions, in particular along their longitudinal extent, it being the case that towers often comprise cylindrical and conical regions. These regions preferably have ring shaped portions. Moreover, such portions can also be formed in ring segment fashion, with the result that a cylindrical portion is composed of different segments in the ring direction. Individual cylindrical and/or conical portions of towers can have, for example, individual part weights of approx. 30 tons to 50 tons. The transport of such portions generally requires large load transportation which is frequently associated with high costs. Furthermore, large load transportation is generally inflexible in terms of time since certain, usually time related, travel restrictions exist in many regions/countries.

Moreover, the handling of such heavy portions on site when erecting a tower can be disadvantageous. Particularly under adverse weather conditions, the erection of a tower is frequently stopped if heavy portions are arranged, since these heavy portions frequently have a large wind impingement area and the wind can thus subject a portion to a force which is difficult to estimate. Moreover, the fastening of the individual portions to one another is associated with challenges. In general, the portions have flanges at their connection points by means of which two vertically adjacent portions and/or horizontally adjacent segment components are connected to one another. The flanges are preferably arranged as an additional component on the portion or segment component. Additionally arranged flanges on the portions or segment components are generally mounted by means of welding. Such segment components are generally distinguished by the fact that they can be connected only with a high degree of effort. In particular, in spite of extremely accurate manufacture, it is generally not possible to produce completely identical segment components with flanges. The existing segmented steel towers and methods for erecting segmented steel towers for wind turbines offer various advantages, but further improvements are desirable.

The German Patent and Trademark Office has searched the following prior art in the priority application to the present application: DE 10 2013 016 604 A1, WO 2016/091 499 A1, DE 103 25 032 B3 and DE 101 26 049 A1.

### BRIEF SUMMARY

Provided is a flange segment for a wind turbine steel tower ring segment, a wind turbine tower portion, a wind turbine tower, a wind turbine and a method for producing a wind turbine steel tower ring segment that alleviate or overcome one or more of the stated disadvantages. In particular, provided is a solution which simplifies the assembly of steel towers for wind turbines. Moreover, provided is a solution which reduces the manufacturing and assembly effort of a wind turbine tower, in particular of portions of the wind turbine tower. Provided is a solution which allows a more cost effective wind turbine.

According to a first aspect of the present invention, provides is a flange segment for a wind turbine steel tower ring segment, comprising a partially ring shaped basic body which extends from a first end to a second end in the ring direction, having an upper side and a lower side opposite the upper side, an inner circumferential side and an outer circumferential side, and a first abutment side on the first end and a second abutment side on the second end, and a flange projection which is arranged on the upper side of the basic body and extends substantially from the first end to the second end in the ring direction.

The flange segment comprises a partially ring shaped basic body which extends from a first end to a second end in the ring direction. The partially ring shaped geometry of the basic body means in particular that the basic body has the geometry of a portion of a ring. The ring shaped basic body further extends in the ring direction, which is preferably oriented parallel to a tangential direction. Moreover, this ring direction is preferably always oriented orthogonally to a radial direction of the partially ring shaped basic body.

The flange segment is preferably formed such that it can be arranged on a wind turbine steel tower ring segment. Moreover, the flange segment is preferably formed in such a way that it is arranged on a first wind turbine steel tower ring segment and is connected to a flange segment of a vertically adjacent second wind turbine steel tower ring segment.

In particular, it is preferred that a total of two flanges, or three flanges, or four flanges, or five flanges, or six flanges, or seven flanges, or eight flanges, or nine flanges, or ten flanges, or eleven flanges, or twelve flanges, or thirteen flanges, or fourteen flanges, or more than fourteen flanges, form a complete ring shape and thus extend over 360 degrees. Moreover, it is particularly preferred that the flange segments arranged on one another form a diameter of greater than 3 meters, in particular greater than 3.5 meters, preferably greater than 4 meters, in particular greater than 4.1 meters.

The partially ring shaped basic body preferably has a width in the orthogonal direction to the ring direction and parallel to the radial direction. A thickness of the basic body preferably extends orthogonally to the width direction or to the direction of the width of the basic body and orthogonally to the ring direction. The partially ring-shaped basic body also has an upper side and a lower side opposite the upper side. The upper side and the lower side are preferably formed by an extent in the ring direction and an extent in the width direction. A surface normal of the upper side and/or of the lower side preferably extends in the thickness direction. Further preferably, a direction component of the surface normal of the upper side and/or of the lower side extends in the thickness direction.

Moreover, the partially ring shaped basic body has the inner circumferential side and the outer circumferential side, which are preferably formed by the extent in the ring direction and in the thickness direction, that is to say in the direction of the thickness. A surface normal of the inner circumferential side and/or of the outer circumferential side preferably extends in the width direction. Further preferably, a direction component of the surface normal of the inner circumferential side and/or of the outer circumferential side extends in the width direction.

Furthermore, the partially ring shaped basic body has the first abutment side on the first end and the second abutment side on the second end, wherein the first abutment side and the second abutment side are preferably formed by an extent of the basic body in the width direction and in the thickness direction. A surface normal of the first abutment side and/or of the second abutment side preferably extends in the ring direction. Further preferably, a direction component of the surface normal of the first abutment side and/or of the second abutment side extends in the ring direction.

In addition to the partially ring shaped basic body, the flange segment has a flange projection which is arranged on the upper side of the basic body. Moreover, the flange projection extends on the upper side of the basic body substantially from the first end to the second end in the ring direction. The extent of the flange projection from the first end to the second end in the ring direction can preferably be interrupted in certain portions. Further preferably, the extent between the first end and the second end is continuous.

The flange segment preferably consists or comprises steel. In particular, it is preferred that a corrosion resistant steel and/or high strength steel are/is used. Moreover, it can be preferred that the flange segment consists of or comprises a nonferrous (NF) metal. Moreover, the flange segment can consist of a material or comprise a material selected from the group consisting of aluminum, plastic, wood, concrete and ceramic. The basic body and the flange projection preferably consist of the same material. Further preferably, the basic body and the flange projection comprise the same material or the same materials. Moreover, it can be preferred that the basic body consists of another material than the flange projection or comprises other materials than the flange projection. In particular, it is preferred that the flange projection consists of a weldable material and comprises the latter at least in certain portions.

The invention is based, inter alia, on the finding that flange segments have clear, unexpected advantages by comparison with ring shaped flanges, as are known, for example, from DE 101 26 049 A1 and DE 103 25 032 B3. Known ring shaped connection flanges have been used hitherto in particular since they allow a high dimensional stability, in particular even in connection methods such as welding. At the same time, large diameter towers represent a major challenge on account of the existing dimension restrictions on existing transport routes. The invention is based, inter alia, on the finding that the required high dimensional stability can be achieved with flange segments when a flange projection is provided. Such a flange projection is particularly suited to be connected to a jacket segment of a steel tower ring segment. It is thereby possible to produce a connection with a steel tower ring segment that has a considerably higher dimensional stability, since, for example, deformations during connection, for instance caused by distortion when welding, are greatly reduced or even avoided.

The invention is based, inter alia, on the finding that an undesired deformation, in particular a distortion, of the wind turbine steel tower ring segment can result from welding flange segments to wind turbine steel tower ring segments. This deformation means that the arrangement of two or more wind turbine steel tower ring segments on one another is possible only with difficulty or the arrangement is not possible. In particular, considerably more complicated positioning and fastening measures are necessary in order to connect the wind turbine steel tower ring segments to one another. In order nevertheless to connect the wind turbine steel tower ring segments or to bring them into an assemblable form, costs arise and the assembly sequence can be disturbed. The flange segment can be arranged on an end side or on an inner or outer circumferential portion of a wind turbine steel tower ring segment and preferably be welded thereto. By virtue of a weld seam on the flange projection of the flange segment, the weld seam is situated at a spaced apart position from the partially ring shaped basic body. The thermal energy occurring during a welding process thus flows substantially into the flange projection and not into the partially ring shaped basic body. Consequently, the basic body is distorted comparatively little, if at all, and consequently in turn, the steel tower ring segment is also deformed only to a very slight degree, if at all.

There now exists the possibility by virtue of the invention of producing the wind turbine steel tower ring segments in series production and of likewise producing the flange segments in series production by means of known manufacturing methods. The arrangement of the flange segment on a corresponding steel tower ring segment can be achieved by means of different welding methods. Preferred welding methods are, for example, submerged arc welding, also known as SA welding, and/or metal welding with active, that is to say reactive, gases, also known as MAG welding, and/or electrode welding.

In a preferred development of the flange segment, there is provision that the flange projection extends in its main direction of extent from a first end to a second end and has a polygonal profile at least in certain portions between the first end and the second end. In this preferred development, the extent of the flange projection preferably does not have a partial ring geometry with a circular portion, but with a polygonal portion having at least one angled off portion. An angled off portion is in particular to be understood as meaning the point at which the main direction of extent changes. At the point of the angled off portion, a recess is preferably formed on the inner circumference. The flange projection preferably has a rectilinear portion between a first angled off portion and a second angled off portion. Further or alternatively preferably, the flange projection has a bent portion between a first angled off portion and a second angled off portion, the radius of this bent portion in particular being less than or greater than the radius of the ring shaped profile of the flange projection. Moreover, it can be preferred that the flange projection has on its inner circumferential surface a round profile between the first end and the second end and has on its outer circumferential surface a polygonal profile between the first end and the second end. Furthermore, it can be preferred that the flange projection has on its outer circumferential surface a round profile between the first end and the second end and has on its inner circumferential surface a polygonal profile between the first end and the second end.

Furthermore, it is preferred that the flange projection is formed in its main direction of extent by two or more rectilinear portions, wherein the rectilinear portions enclose an angle which is preferably less than or equal to 6 degrees and/or less than or equal to 12 degrees and/or greater than 12 degrees. In particular, it is preferred that the two or more rectilinear portions of the flange projection form a polygonal profile of the flange projection.

A polygonal profile and/or two or more rectilinear portions can offer the particular advantage that an angled off wind turbine tower segment can be arranged on the flange segment. In particular, generally an improved and especially a firmer and more favorable connection is made possible. The costs of an overall wind turbine tower can thus be considerably reduced, in spite of the strength remaining the same or being better.

In a preferred embodiment variant of the flange segment, there is provision that it comprises an outer upper edge which is formed by the upper side and the outer circumferential side, and/or an inner upper edge which is formed by the upper side and the inner circumferential side, wherein the flange projection adjoins the outer upper edge and/or the inner upper edge, wherein preferably an outer side of the flange projection is aligned with the outer circumferential side such that the outer side of the flange projection and the outer circumferential side of the basic body form a flange segment outer surface, and/or wherein preferably an inner side of the flange projection is aligned with the inner circumferential side such that the inner side of the flange projection and the inner circumferential side of the basic body form a flange segment inner surface.

A flange projection which adjoins the outer upper edge particularly has the advantage that, upon arrangement of the flange segment on an inner circumferential surface of a wind turbine steel tower ring segment, said projection can be arranged directly on the inner circumference surface of the steel tower ring segment and can be welded here to the latter. The arrangement of the flange projection on an inner upper edge particularly has the advantage that the fastening of the flange segment to a wind turbine steel tower ring segment at its end side can occur in a particularly advantageous manner.

According to a further preferred embodiment variant of the flange segment, there is provision that the flange projection is arranged in the radial direction, in particular in the width direction, between the outer upper edge and the inner upper edge in such a way that an outer shoulder face whose surface normal is preferably formed orthogonally to the ring direction and to the radial direction is formed between the flange projection and the outer upper edge, and/or an inner shoulder face whose surface normal is preferably oriented orthogonally to the ring direction and to the radial direction is formed between the flange projection and the inner upper edge. The shoulder faces are substantially the faces of the upper side on which the flange projection and elements corresponding thereto, for example the extensions still to be described below, are not arranged.

The shoulder faces can serve for example as arrangement faces for the wind turbine steel tower ring segments, with it being particularly preferred to arrange a flange segment formed in such a way on the end side of the wind turbine steel tower ring segments. In particular, the wind turbine steel tower ring segments can be arranged on these shoulder faces such that the shoulder faces, optionally in combination with the flange projection, function as a positioning aid. A form fitting positioning of the flange segment on the wind turbine steel tower ring segments can thus be realized, with the result that the fastening of the flange segments to the wind turbine steel tower ring segments is simplified.

It is further preferred that a transition from the flange projection to the inner shoulder face is formed by a freeform face, wherein the freeform face is preferably formed in such a way that a radius is formed between an inner circumferential side of the flange projection that faces the inner shoulder face and the inner shoulder face. Furthermore, a development is preferred in which a transition from the flange projection to the outer shoulder face is formed by a freeform face, wherein the freeform face is preferably formed in such a way that a radius is formed between an outer circumferential side of the flange projection that faces the outer shoulder face and the outer shoulder face. In particular, it is preferred that the radius is less than 3 mm, and/or less than 5 mm, and/or less than 10 mm, and/or greater than 10 mm. Further preferably, the freeform face is of convex and/or concave design. Moreover, the transition can also take the form of a fillet seam.

A further preferred development of the flange segment is distinguished by the fact that the outer shoulder face and/or the inner shoulder face have/has one, two or more through passage openings whose through passage direction or whose through passage directions is/are preferably oriented parallel to the surface normal of the outer shoulder face and/or of the inner shoulder face and/or thickness direction. The through passage openings particularly allow the arrangement of the flange segment on an adjacent fastening element, preferably a further flange segment. In particular, it is preferred that the flange segment has three or more through passage openings which are spaced apart from one another equidistantly and further preferably have center points which are arranged on a curve in the ring direction.

Furthermore, there is preferably provision that the flange projection extends from a first projection end to a second projection end, and a first extension is arranged on the first projection end and/or a second extension is arranged on the second projection end, wherein the first extension and/or the second extension extend/extends in the radial direction, and/or the first extension extends in the direction of a first lateral upper edge which is formed by the upper side and the first abutment side, and/or the second extension extends in the direction of a second lateral edge which is formed by the upper side and the second abutment side.

The extensions preferably have a main direction of extent in which the extensions extend in the direction of their length. The extensions preferably have a length which is greater than a width and a height. It is particularly preferred that the main directions of extent of the extensions are oriented substantially parallel to the radial direction and/or width direction.

One or two extensions of the flange projection can particularly improve the arrangement of the flange segment on wind turbine steel tower ring segments. In particular angled off flanges on vertical abutment sides of wind turbine steel tower ring segments can be directly connected by their horizontal abutment sides to the extensions of the flange projection. This results in an improved and more secure arrangement of the flange segment on wind turbine steel tower ring segments.

It is further preferred that the basic body has a basic body cross sectional area whose surface normal is oriented parallel to the ring direction, wherein the basic body cross sectional area has a triangular, quadrangular, in particular a square, and/or polygonal cross section. The flange projection preferably has a projection cross sectional area which is constant along its extent with respect to its size and its geometry. Further preferably, the flange projection has a projection cross sectional area along its extent which is variable with respect to its size and/or geometry. In particular, it is preferred that the projection cross sectional area has a quadrangular, in particular a square, cross section. Further preferably, the projection cross sectional area can have a triangular cross section and/or a semicircular cross section. In particular, it is preferred that the projection cross sectional area is tapered in a portions facing away from the upper side, and preferably has a bevel and/or is chamfered at its end facing away from the upper side, and/or the projection cross sectional area has a first cross section portion facing the upper side, and a second cross section portion facing away from the upper side and arranged on the first cross section portion, wherein the second cross section portion has a substantially triangular geometry and/or a trapezoidal geometry.

There is further preferably provision that the flange segment is formed in one piece. The flange segment is preferably produced from solid, wherein in particular a milling method can be used. Further preferably, the flange segment is produced by a forming technique, for example by means of a casting method and an additive manufacturing method.

According to a further aspect of the present invention, provided is a wind turbine steel tower ring segment comprising a jacket segment having an extent in the direction of a height, a ring direction and a width, comprising a first horizontal abutment side and a second horizontal abutment side, wherein, in the mounted state, the first horizontal abutment side faces a tower foundation and the second horizontal abutment side faces a tower tip, wherein a flange segment as claimed in at least one of the previously stated embodiment variants is arranged and/or can be arranged on the first horizontal abutment side and/or on the second horizontal abutment side.

In the operating mode, the height of the wind turbine steel tower ring segment preferably extends substantially parallel to the height or longitudinal extent of the tower. Also included here are conical portions of a tower which indeed have an angle to the extent in the direction of the height or the longitudinal extent of the tower, but, given the dimensions of a tower, this angle is small enough that it can be disregarded here.

The width of the wind turbine steel tower ring segment preferably extends in the radial direction. The ring direction is preferably substantially orthogonal to the height and to the width of the wind turbine steel tower ring segment. The first horizontal abutment side and the second horizontal abutment side are preferably formed by the extent of the wind turbine steel tower ring segment in the ring direction and in the direction of the width. The arrangement of the flange segment on the first horizontal abutment side and/or on the second horizontal abutment side can occur, for example, on the end side. Alternatively or additionally, the flange segment can also be arranged on an inner circumferential surface of the wind turbine steel tower ring segment. In a particularly preferred embodiment variant, the flange segment is formed in such a way that it is arranged on the end side and inner circumferential side of the wind turbine steel tower ring segment. Furthermore, the flange segment can also be completely or partially arranged on an outer circumferential portion of the wind turbine steel tower ring segment.

Moreover, such a wind turbine steel tower ring segment results in the fact that a better introduction of load into a wind turbine steel tower ring segment is achieved on account of better load distribution within the component via friction and prestressing force of the bolts.

A preferred embodiment variant of the wind turbine steel tower ring segment provides that the flange segment is connected and/or can be connected to the wind turbine steel tower ring segment by means of a connection which is arranged in a region which adjoins the flange projection and the wind turbine steel tower ring segment. Moreover, it is preferred that the connection is formed as at least one weld seam. A weld seam is the result of a welding process which represents the nonreleasable connection of components using heat and/or pressure with or without welding filler materials. The connection of the flange segment to the wind turbine steel tower ring segment is preferably achieved by means of pressure welding. Moreover, it is preferred that fusion welding is used. In particular, it is preferred that the flange segment is arranged and formed in such a way that a fillet seam can be arranged. Moreover, it can be preferred that a butt seam is arranged.

In a particularly preferred development of the wind turbine steel tower ring segment, the latter comprises a first vertical abutment side and a second vertical abutment side which are arranged substantially orthogonally to the horizontal abutment sides, wherein a first vertical flange is arranged on the first vertical abutment side, and/or wherein a second vertical flange is arranged on the second vertical abutment side, wherein the first vertical flange and/or the second vertical flange are/is arranged and formed in such a way that they can be connected to a vertical flange of an adjacent wind turbine steel tower ring segment, and wherein the first vertical flange and/or the second vertical flange project/projects inwardly in the radial direction.

A vertical abutment side is particularly to be understood as meaning an abutment side which, in the operating mode, extends substantially in the vertical direction. Particularly to be understood by this is an abutment side which is oriented substantially parallel to a height of a wind turbine tower. In the case of conical towers or towers having conical portions, the extent of the conical elements is also to be understood as vertical. A surface normal of the vertical abutment side is preferably oriented substantially in the ring direction. The first vertical flange and/or the second vertical flange project/projects inwardly in the radial direction. This means in particular that surface normals of the flanges are oriented in the ring direction. These surface normals are particularly situated on those surfaces of the flanges which are formed and arranged to bear against a further flange in order then to connect them. Further preferably, the flanges have through passage openings which preferably have through passage directions which are oriented in the ring direction.

Moreover, it is preferred that the jacket segment has a partially ring shaped cross section whose surface normal is oriented substantially parallel to the height, and wherein the partially ring shaped cross section has a partially ring shaped geometry. Furthermore, it is preferred that the partially ring shaped cross section of the jacket segment is formed by two or more rectilinear portions, wherein the two or more rectilinear portions are arranged at an angle to one another. Two or more portions arranged at an angle to one another give rise to an angled lateral surface. Moreover, it is preferred that the first vertical flange is formed by a rectilinear portion which is arranged at an angle to the jacket segment, and/or the second vertical flange is formed by a rectilinear portion which is arranged at an angle to the jacket segment. Vertical flanges formed in such a way particularly form angled off flanges which are suitable in particular for connecting two horizontally adjacent wind turbine steel tower ring segments. In a preferred development, there is further provision that the jacket segment and the first vertical flange and the second vertical flange are formed in one piece.

In particular, it is preferred that an angle to the jacket segment of less than 90 degrees prevails between the rectilinear portion of the first vertical flange and/or the second vertical flange. In particular, it is preferred that the first vertical flange and/or the second vertical flange consist/consists of the same material as the jacket segment. Moreover, it is preferred that the first vertical flange and the second vertical flange are bent over portions of the jacket segment, with the result that angled off flanges are formed. In particular, it is preferred that the bent over portions are incorporated by a bending method. In a preferred embodiment variant of the wind turbine steel tower ring segment, there is further provision that it consists of steel or comprises steel. Further preferably, the wind turbine steel tower ring segment can consist of or comprise aluminum.

According to a further aspect of the present invention, provided is a wind turbine tower portion, comprising at least a first wind turbine steel tower ring segment according to at least one of the previously described embodiment variants and a second wind turbine steel tower ring segment according to at least one of the previously described embodiment variants, wherein the first wind turbine steel tower ring segment and the second wind turbine steel tower ring segment butt against one another with in each case one of the vertical abutment sides at least one substantially vertical joint. In particular, it is preferred that the wind turbine steel tower ring segments have vertical flanges, in particular with through-passage openings, at which they can be fastened to an adjacent wind turbine steel tower ring segment. In particular, it is preferred that the wind turbine tower portion has two or more wind turbine steel tower ring segments. Furthermore, it is preferred that the wind turbine steel tower ring segments are arranged at the vertical joint with a tolerance of plus/minus 0.1 mm and/or plus/minus 0.2 mm.

According to a further aspect of the present invention, provided is a wind turbine tower, comprising two or more wind turbine tower portions arranged above one another, according to the previously stated aspect. In particular, it is preferred that the wind turbine tower portions arranged above one another comprise flange segments according to the previously described embodiment variants, and wind turbine tower portions arranged adjacently above one another are fastened to one another by means of the flange segments. Moreover, it is preferred that the wind turbine tower portions consisting of wind turbine steel tower ring segments are arranged above one another in such a way that a first joint of a first wind turbine tower portion in the vertical direction is not arranged directly above a joint of a second wind turbine tower portion.

According to a further aspect of the present invention, provided is a wind turbine comprising a wind turbine tower according to the previously described aspect.

According to a further aspect of the present invention, provided is a method for producing a wind turbine steel tower ring segment, in particular a wind turbine steel tower ring segment according to the previously described embodiment variants, comprising providing a jacket segment having an extent in the direction of a height, a ring direction and a width, comprising a first horizontal abutment side and a second horizontal abutment side, wherein, in the mounted state, the first horizontal abutment side faces a tower foundation and the second horizontal abutment side faces a tower tip, producing and providing at least one flange segment, in particular a flange segment according to at least one of the previously described embodiment variants, wherein the flange segment is preferably produced from one piece of raw material, in particular by means of a milling method, arranging a flange segment on a first inner circumferential portion which adjoins the first horizontal abutment side, and/or arranging a flange segment on a second inner circumferential portion which adjoins the second horizontal abutment side, and connecting the flange segment or the flange segments to the jacket segment, wherein preferably the connection of the flange segment or of the flange segments to the jacket segment is achieved by means of a welding seam which is preferably arranged in a region adjoining the flange projection and the wind turbine steel tower ring segment.

According to a further aspect of the present invention, provided is a method for producing a wind turbine tower portion, in particular a wind turbine tower portion according to one of the previously described embodiment variants, comprising providing at least a first wind turbine steel tower ring segment and a second wind turbine steel tower ring segment, in particular a first wind turbine steel tower ring segment according to at least one of the previously described embodiment variants and a second wind turbine steel tower ring segment according to at least one of the previously described embodiment variants, arranging the first wind turbine steel tower ring segment and the second wind turbine steel tower ring segment at least one vertical joint with in each case one of the vertical abutment sides, connecting the first wind turbine steel tower ring segment and the second wind turbine steel tower ring segment at the at least one vertical joint, wherein preferably the first wind turbine steel tower ring segment and the second wind turbine steel tower ring segment have vertical flanges which are arranged on the inner circumferential surface adjoining the edge toward the first abutment side and/or second abutment side, wherein further preferably the first wind turbine steel tower ring segment and the second wind turbine steel tower ring segment are connected to one another by the fastening of two adjacent vertical flanges.

### BRIEF DESCRIPTION OF THE SEVERAL VIEWS OF THE DRAWINGS

The methods according to the invention and their possible developments have features or method steps which make them particularly suitable to be used for a flange segment according to the invention and its developments. For further advantages, embodiment variants and embodiment details of these further aspects and their possible developments, reference is also made to the above given description of the corresponding features and developments the flange segment. Preferred embodiments of the invention will be explained by way of example on the basis of the appended figures, in which:

FIG. 1 shows a schematic view of an exemplary embodiment of a wind turbine;

FIG. 2 shows a schematic, three dimensional view of an exemplary embodiment of a wind turbine tower;

FIG. 3 shows a schematic, three dimensional detail view of the tower from FIG. 2;

FIG. 4 shows a schematic, three dimensional view of an exemplary embodiment of a wind turbine steel tower ring segment;

FIG. 5a shows a schematic, three dimensional view of an exemplary embodiment of a flange segment;

FIG. 5b shows a detail view of the embodiment shown in FIG. 5a;

FIG. 6 shows a schematic, three dimensional view of an exemplary embodiment of a connection between four wind turbine steel tower ring segments with flange segments; and

FIG. 7 shows a schematic, three dimensional view of four interconnected wind turbine steel tower ring segments.

In the figures, identical or substantially functionally identical or similar elements are designated by the same reference signs.

### DETAILED DESCRIPTION

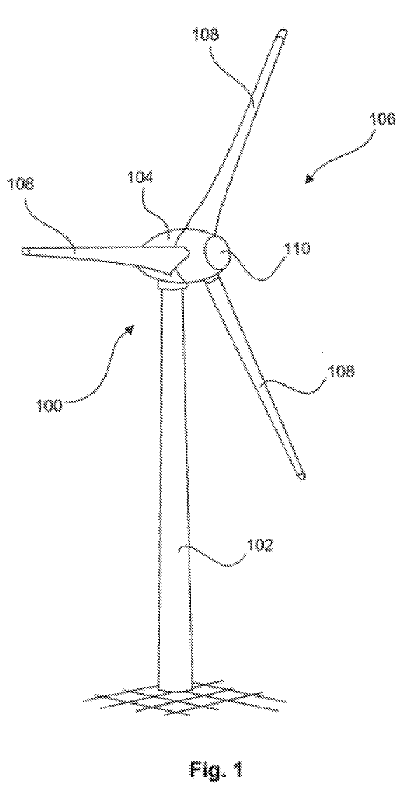

FIG. 1 shows a schematic, three dimensional view of an exemplary embodiment of a wind turbine. FIG. 1 particularly shows a wind turbine 100 having a tower 102 and a nacelle 104. A rotor 106 with three rotor blades 108 and a spinner 110 is arranged on the nacelle 104. In operation, the rotor 106 is set into a rotational movement by the wind and thereby drives a generator in the nacelle 104. The tower 102 particularly has wind turbine steel tower ring segments with flange segments. As a result, the tower 102 is built up by means of components which are simple to transport and which moreover can be connected with a high degree of precision and little effort.

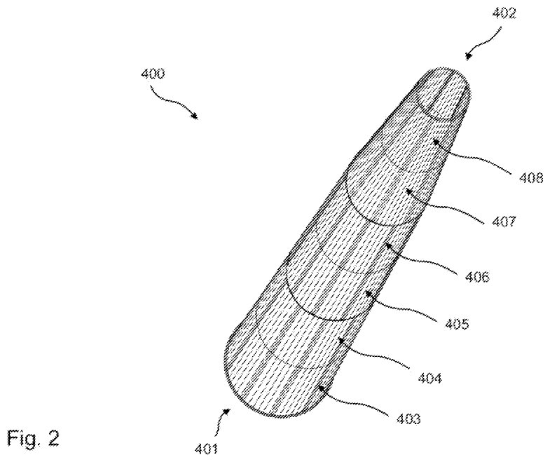

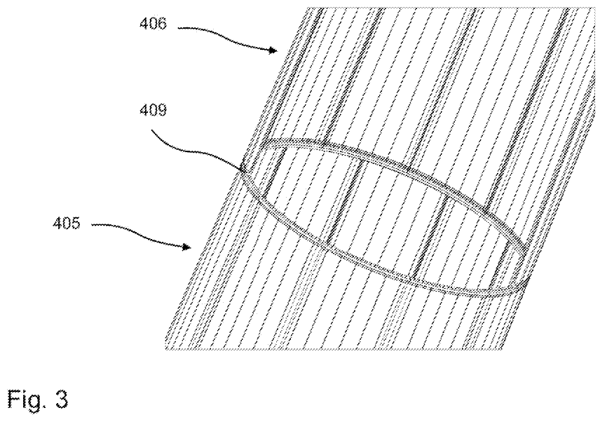

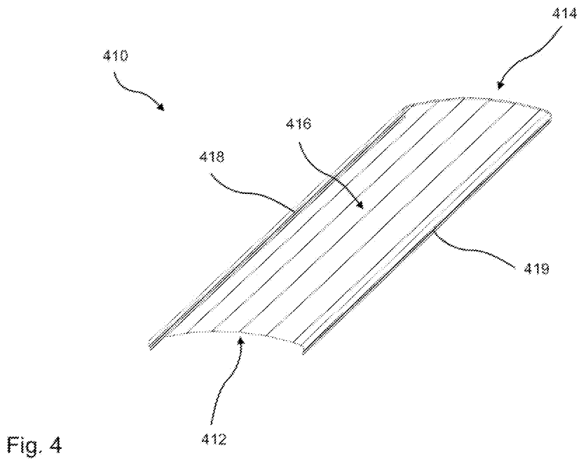

FIG. 2 shows a schematic, three dimensional view of an exemplary embodiment of a wind turbine tower. The tower 400 extends in the longitudinal direction from a foundation end 401 to a head end 402. In the operating mode or in the erected state, the longitudinal direction of the tower 400 is oriented in the direction of the height of the tower 400. The tower 400 comprises six tower portions 403 408. It can particularly be seen in FIG. 3 that the tower portions, the third tower portion 405 and the fourth tower portion 406 being shown here, are arranged on one another at a horizontal joint 409. It can also be seen in FIGS. 2 and 3 that the tower portions 403 408 have wind turbine steel tower ring segments, of which an individual one is shown by way of example in FIG. 4.

The ring segment 410 shown in FIG. 4 extends from a first end 412 to a second end 414. In the mounted state, the first end 412 preferably faces the foundation of the tower and the second end 414 faces the tower head. The ring segment 410 also has a cross section whose surface normal is oriented substantially parallel to the height, and wherein the cross section has a partially ring shaped geometry. The partially ring shaped cross section of the ring segment 410 is formed by a plurality of rectilinear portions, wherein the plurality of rectilinear portions are arranged at an angle to one another. The ring segment 410 consequently has an angled lateral surface 416. The angled lateral surface is for example, as shown here, formed by a total of seven rectilinear portions, wherein the seven rectilinear portions are arranged at an angle to one another. As is particularly evident from FIG. 3, an individual tower portion can have, for example, a total of ten ring segments arranged adjacent to one another in the horizontal direction.

To form a tower portion, the ring segments are arranged on one another at vertically oriented abutment surfaces. At the abutment surfaces, the ring segment 410 has a first angled off flange 418 and, on the oppositely arranged vertical abutment side, a second angled off flange 419. The first angled off flange 418 and the second angled off flange 419 are each formed by a rectilinear portion which is arranged at an angle to the ring segment 410.

The first angled off flange 418 and the second angled off flange 419 are particularly arranged and formed in such a way that, upon arranging the ring segment 410 when forming the tower portion, the flanges are oriented in such a way that through passage openings arranged thereon have through passage directions which are oriented substantially parallel to the ring direction.

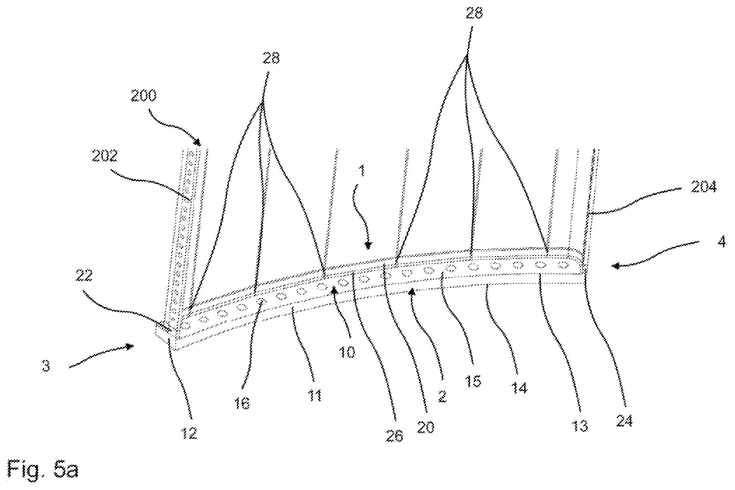

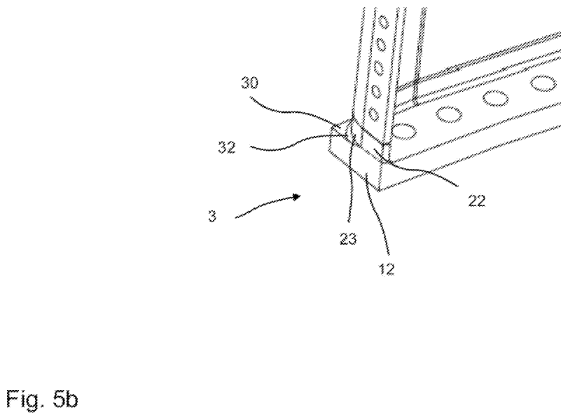

FIG. 5a shows a schematic, three dimensional view of an exemplary embodiment of a flange segment. The flange segment 1 has a basic body 2 and a flange projection 20. The basic body 2 extends in the ring direction from a first end 3 to a second end 4. The basic body 2 has an inner circumferential side 11 which is formed by the extent of the basic body 2 in the ring direction and in the thickness direction. Moreover, the basic body 2 has a first abutment side 12 which is formed by the extent of the basic body in the width direction and in the thickness direction. Moreover, the basic body has an upper side 10 which is formed by the extent in the ring direction and the extent in the width direction.

The upper side 10 and the inner circumferential side 11 form an upper inner edge 13. The lower side arranged opposite the upper side 10 forms a lower inner edge 14 with the inner circumferential side 11. Moreover, through passage openings 16 are arranged equidistantly on the upper side 10, the through passage direction of which is oriented substantially in the thickness direction. An outer circumferential side is arranged opposite the inner circumferential side 11. The outer circumferential side forms an upper outer edge with the upper side 10.

The flange projection 20 likewise extends in its main direction of extent in the ring direction from a region adjoining the first end 3 of the basic body 2 to a region adjoining the second end 4 of the basic body 2. The flange projection 20 has a polygonal profile between its first end and its second end between which the main direction of extent extends. Consequently, the flange projection 20 has six angled off portions 28 along its main direction of extent, wherein straight lines which enclose an angle extend along the main direction of extent between the angled off portions. Moreover, it is shown that the transition 26 from the flange projection 20 to the inner shoulder face 15 is formed by a freeform face, wherein the freeform face is formed in such a way that a radius is formed. The inner shoulder face 15 is the part of the surface 10 which is located to the inner side of the flange projection 20.

The flange projection 20 has a first extension 22 at its end in the region of the first end 3. The first extension 22 extends in its main direction of extent substantially in the width direction. In an analogous manner, the flange projection 20 has a second extension 24 at the second end 4 of the basic body 2. The extensions 22, 24 advantageously allow a ring segment 200 having angled off flanges 202, 204 to be arranged on the flange segment 1.

It can be seen in detail in FIG. 5b that the extension 22 terminates in the flange projection 20 at the first end 3 by means of an extension piece 23. It can also be seen that the extension piece 23 and the outer circumferential side of the flange projection 20 merge by means of a transition 32 into the outer shoulder face 30. The outer shoulder face 30 is the part of the surface 10 which is located to the outer side of the flange projection 20. The transition 32 extends away along the main direction of extent of the flange projection 20 such that the outer circumferential side of the flange projection 20 merges into the outer shoulder face 30 by means of the transition 32.

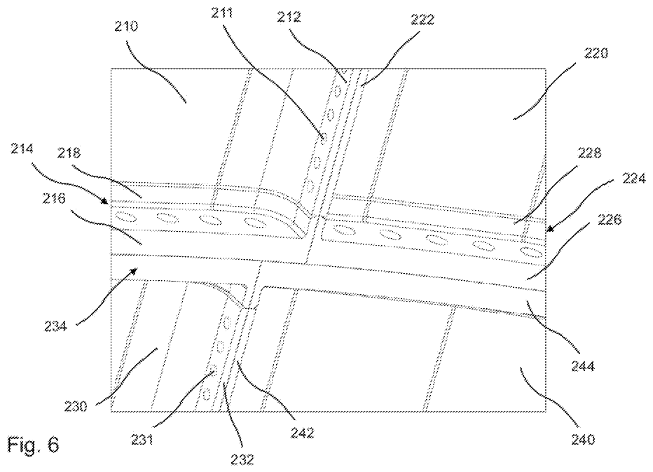

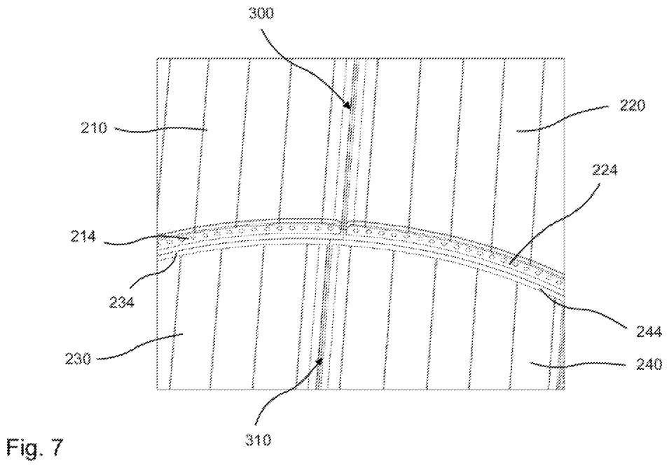

It is shown in FIGS. 6 and 7 how a total of four ring segments can be connected to one another horizontally and vertically. The first ring segment 210 and the second ring segment 220 form a subportion of a first wind turbine tower portion. The third ring segment 230 and the fourth ring segment 240 form a subportion of a second wind turbine tower portion. The first wind turbine tower portion is arranged adjacently above the second wind turbine tower portion. The first ring segment 210 and the second ring segment 220 are arranged on one another at a vertical joint 300. The third ring segment 230 and the fourth ring segment 240 are arranged on one another at a vertical joint 310.

The vertical joint 300 and the vertical joint 310 are not arranged directly above one another in the vertical direction but are offset from one another. The first ring segment 210 has a first flange segment 214, the second ring segment 220 has a second flange segment 224, the third ring segment 230 has a third flange segment 234, and the fourth ring segment 240 has a fourth flange segment 244. The flange segments 214, 224, 234, 244 are arranged on the ring segments 210, 220, 230, 240 according to the above given description. The vertically adjacent flange segments can be connected to one another by means of the through passage openings arranged in the flange segments.

It is particularly shown in FIG. 6 how the flange segments 214, 224, 234, 244 are arranged on the ring segments 210, 220, 230, 240. Moreover, it is shown how the vertical connection of two horizontally adjacent ring segments occurs. The vertical flanges 212, 222, 232, 242 also have through passage openings 211, 231 whose through passage direction is oriented substantially in the ring direction. The vertical flanges can be connected to one another by means of the through passage openings and suitable fastening elements, for example nuts and bolts.

The flange segments 214, 224, 234, 244 allow ring segments 200, 210, 220, 230, 240 to be connected to one another in a particularly advantageous manner. The flange segments can be arranged on the ring segments in an advantageous manner by means of the formation of the flange projection on the flange segments. Said flange segments can be arranged on the ring segments in a simple manner particularly by means of a welding method, with reduced distortion, if any, of the ring segments occurring as a result of the introduction of heat during the welding process.

### REFERENCE SIGNS

1 Flange segment

2, 216, 226 Basic body

3 First end

4 Second end

10 Upper side

11 Inner circumferential side

12 First abutment side

13 Inner upper edge

14 Inner lower edge

15 Inner shoulder face

16 Through passage opening

20, 218, 228 Flange projection

22 First extension

23 Extension piece

24 Second extension

26, 32 Transition

28 Angled off portion

30 Outer shoulder face

100 Wind turbine

102, 400 Tower

104 Nacelle

106 Rotor

108 Rotor blade

110 Spinner

200 Ring segment

202, 418 First angled off flange

204, 419 Second angled off flange

210 First ring segment

211 Through passage opening

212, 222, 232, 242 Angled off flange

214 First flange segment

220 Second ring segment

224 Second flange segment

230 Third ring segment

231 Through passage opening

234 Third flange segment

240 Fourth ring segment

244 Fourth flange segment

300, 310 Vertical joint

401 Foundation end

402 Head end

403 First tower portion

404 Second tower portion

405 Third tower portion

406 Fourth tower portion

407 Fifth tower portion

408 Sixth tower portion

409 Horizontal joint

410 Ring segment

412 First end

414 Second end

416 Angled lateral surface

418 First vertical flange

419 Second vertical flange

1. A flange segment for a wind turbine steel tower ring segment, comprising:
a partially ring shaped basic body which extends from a first end to a second end in a ring direction, the partially ring shaped basic body having:
an upper side and a lower side opposite the upper side,
an inner circumferential side and an outer circumferential side, and
a first abutment side at the first end and a second abutment side at the second end,
a flange projection which:
is arranged at the upper side of the partially ring shaped basic body, and
extends substantially from the first end to the second end in the ring direction.

2. The flange segment as claimed in claim 1, wherein the flange projection has a main direction of extent from a first projection end to a second projection end and has a polygonal profile between the first projection end and the second projection end,
wherein the flange projection is formed in the main direction of extent by two or more rectilinear portions, wherein the rectilinear portions enclose an angle.

3. The flange segment as claimed in claim 1, comprising:
an outer upper edge formed by the upper side and the outer circumferential side, and
an inner upper edge formed by the upper side and the inner circumferential side, wherein the flange projection adjoins the outer upper edge and the inner upper edge, wherein an outer side of the flange projection is in alignment with the outer circumferential side such that the outer side of the flange projection and the outer circumferential side of the partially ring shaped basic body form a flange segment outer surface.

4. The flange segment as claimed in claim 1,
wherein the flange projection is arranged in the radial direction between the outer upper edge and the inner upper edge in such a way that an outer shoulder face has a surface normal that is oriented orthogonally to the ring direction and to the radial direction, wherein the outer shoulder face is between the flange projection and the outer upper edge, and
an inner shoulder face having a surface normal that is oriented orthogonally to the ring direction and to the radial direction, wherein the inner should face is between the flange projection and the inner upper edge.

5. The flange segment as claimed in claim 1, wherein:
a transition from the flange projection to the inner shoulder face is formed by a freeform face, wherein the freeform face is formed in such a way that a radius is formed between an inner circumferential side of the flange projection that faces the inner shoulder face and the inner shoulder face, and
a transition is formed from the flange projection to the outer shoulder face by a freeform face, wherein the freeform face is formed in such a way that a radius is formed between an inner circumferential side of the flange projection that faces the outer shoulder face and the outer shoulder face.

6. The flange segment as claimed in claim 1, wherein:
the flange projection extends from a first projection end to a second projection end, and a first extension is arranged on the first projection end and a second extension is arranged on the second projection end, wherein the first extension and the second extension extend in a radial direction, and
the first extension extends in the direction of a first lateral upper edge which is formed by the upper side and the first abutment side, the second extension extends in the direction of a second lateral edge which is formed by the upper side and the second abutment side.

7. A wind turbine steel tower ring segment, comprising:
a jacket segment having a height, a ring depth and a width, the jacket segment comprising:
a first horizontal abutment side and a second horizontal abutment side, wherein, in the mounted state, the first horizontal abutment side faces a tower foundation and the second horizontal abutment side faces a tower tip,
wherein a flange segment as claimed in claim 1 is arranged on at least one of the first horizontal abutment side or the second horizontal abutment side.

8. The wind turbine steel tower ring segment as claimed in claim 7, wherein:
the flange segment is connected to the wind turbine steel tower ring segment by a connection which is arranged in a region which adjoins the flange projection and the wind turbine steel tower ring segment.

9. The wind turbine steel tower ring segment as claimed in claim 7, comprising:
a first vertical abutment side,
a second vertical abutment side which is arranged substantially orthogonally to the horizontal abutment side,
a first vertical flange arranged on the first vertical abutment side,
a second vertical flange arranged on the second vertical abutment side,
wherein the first vertical flange and the second vertical flange are arranged and formed in such a way to be connected to a vertical flange of an adjacent wind turbine steel tower ring segment, and
wherein the first vertical flange and the second vertical flange project inwardly in a radial direction.

10. The wind turbine steel tower ring segment as claimed in claim 7, wherein the jacket segment has a partially ring shaped cross section whose surface normal is oriented substantially parallel to the height, and wherein:
the partially ring shaped cross section has a partially ring shaped geometry,
the partially ring shaped cross section of the jacket segment is formed by two or more rectilinear portions, wherein the two or more rectilinear portions are arranged at an angle to one another,
the first vertical flange is formed by a rectilinear portion which is arranged at an angle to the jacket segment,
the second vertical flange is formed by a rectilinear portion which is arranged at an angle to the jacket segment, and
the jacket segment and the first vertical flange and the second vertical flange are formed as a single integral piece.

11. A wind turbine tower portion, comprising:
first and second wind turbine steel tower ring segments, wherein the first and second wind turbine steel tower ring segments are respective ones of the wind turbine steel tower ring segment as claimed in claim 7,
wherein the first wind turbine steel tower ring segment and the second wind turbine steel tower ring segment abut against one another at vertical abutment sides at a substantially vertical joint.

12. A wind turbine tower, comprising two or more wind turbine tower portions as claimed in claim 11 that are arranged vertically stacked relative to one another.

13. A wind turbine, comprising a wind turbine tower as claimed in claim 12.

14. A method for producing a wind turbine steel tower ring segment, the method comprising:
providing a jacket segment having an extent in a direction of a height, a ring direction and a width, the jacket segment comprising a first horizontal abutment side and a second horizontal abutment side, wherein, in the mounted state, the first horizontal abutment side faces a tower foundation and the second horizontal abutment side faces a tower tip,
providing at least one flange segment as claimed in claim 1,
arranging a first flange segment on a first inner circumferential portion which adjoins the first horizontal abutment side,
arranging a second flange segment on a second inner circumferential portion which adjoins the second horizontal abutment side, and
connecting the first and second flange segments to the jacket segment.

15. A method for producing a wind turbine tower portion, the method comprising:
providing at least a first wind turbine steel tower ring segment and a second wind turbine steel tower ring segment, wherein the first and second wind turbine steel tower ring segments are wind turbine steel tower ring segment as claimed in claim 7,
arranging the first wind turbine steel tower ring segment and the second wind turbine steel tower ring segment such that at least one vertical joint is formed at vertical abutment sides of the first and second wind turbine steel tower ring segments, and
connecting the first wind turbine steel tower ring segment and the second wind turbine steel tower ring segment at the at least one vertical joint,
wherein the first wind turbine steel tower ring segment and the second wind turbine steel tower ring segment have vertical flanges which are arranged on an inner circumferential surface adjoining the edge toward the first abutment side and/or second abutment side, and
wherein the first wind turbine steel tower ring segment and the second wind turbine steel tower ring segment are connected to one another by fastening of the respective adjacent vertical flanges.

16. The flange segment as claimed in claim 3, wherein an inner side of the flange projection is in alignment with the inner circumferential side such that the inner side of the flange projection and the inner circumferential side of the partially ring shaped basic body form a flange segment inner surface.

17. The flange segment as claimed in claim 6, wherein the flange segment is a single integral piece.

18. The method as claimed in claim 14, wherein connecting the first and second flange segments to the jacket segment is achieved by a welding seam arranged in a region adjoining the flange projection and the wind turbine steel tower ring segment.
